(19) United States
(12) Patent Application Publication
(10) Pub. No.: US 2020/0143583 A1
(43) Pub. Date: May 7, 2020

(54) CLOUD RENDER SERVICE FRAMEWORK FOR LOW POWER PLAYBACK DEVICES

(71) Applicant: HypeVR, San Diego, CA (US)

(72) Inventors: Caoyang Jiang, San Diego, CA (US); Jason Juang, San Diego, CA (US); Anthony Tran, San Diego, CA (US); Jiang Lan, San Diego, CA (US)

(21) Appl. No.: 16/677,493

(22) Filed: Nov. 7, 2019

Related U.S. Application Data
(60) Provisional application No. 62/756,704, filed on Nov. 7, 2018.

(51) Int. Cl. G06T 15/20; H04L 29/06; H04L 29/08

(52) U.S. Cl. CPC G06T 15/20; H04L 67/38; G06T 2200/16; H04L 67/101; H04L 67/16; H04L 67/1021

(57) ABSTRACT

A system and method for selecting a cloud render service for performing rendering from among a plurality of geographically distributed cloud render services based, at least in part, upon a latency between the device and the plurality of geographically distributed cloud render services; instructing the cloud render service to utilize a compute node for rendering the volumetric video; and rendering of the volumetric video on the compute node. The rendering includes receiving positional tracking data from the device indicating a perspective of a viewing device on the volumetric video; rendering a selected volumetric video from the perspective; and generating a two-dimensional video stream to correspond to the perspective of the selected volumetric video.

### RELATED APPLICATION INFORMATION

This patent claims priority from U.S. provisional patent application No. 62/756,704 entitled “CLOUD RENDER SERVICE FRAMEWORK FOR LOW POWER PLAYBACK DEVICES” filed Nov. 7, 2018, the entirety of which is incorporated by reference.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

### Field

This disclosure relates generally to methods for performing rendering on a cloud-based system to better-enable low power systems, such as mobile devices, to render six degree of freedom three-hundred sixty degree augmented reality and virtual reality content.

### Description of the Related Art

In computer graphics, rendering is the automatic process that creates a two-dimensional projection image from a three-dimensional model. Common uses of rendering are found in computer games and three-dimensional arts where photo-realistic views may be created from three-dimensional objects modeled in computer languages and functions. Depending on the time spent on the computing process, rendering can be divided into real-time rendering and static rendering. Computer games are an example of real-time rendering where the player's viewing content changes throughout game play at the direction of an individual player or group of players. Usually, a minimum of 60 frames-per-second rendering rate (or refresh rate) is a desirable benchmark to ensure smooth gaming experience. Typically, advanced graphics-specific processors are employed to ensure that the computer has sufficient capabilities to render the real-time three-dimensional images at sufficient speed.

In contrast, computer-generated movies use static rendering, where the time spent on rendering a single frame can be minutes, hours, or even days. This enables the three-dimensional images to be incredibly life-like or accurate. The resulting images are so realistic that an ordinary human being may not be able differentiate them from reality. As the demand for higher quality graphics increases, the rendering process becomes significantly more complex and time consuming.

A central processing unit (CPU) is capable of carrying out rendering tasks. However, as graphical complexity has increased, CPUs' general-purpose instruction set has made them a poor choice for most graphical processing. A different advanced hardware called a Graphic Processing Unit (GPU) is designed for, and dedicated to, operating upon computer graphics. For example, GPUs typically include specialized instruction sets, extremely high-speed memory, and integration with software application programmable interfaces (APIs) that are created for graphical processing. The GPU is, thus, much better suited to rendering and is several magnitudes faster than CPU for rendering-related tasks. On the market today, nVIDIA® and AMD® are the two primary vendors of discrete high-performance GPUs. In spite of the high price of these devices, professional users and gamers who wish to keep up with the best experience replace their hardware quite often as newer and better GPUs often.

The arrival of cloud computing technology and the increasing demand for computer graphic related applications have given rise to a new type of rendering technology called cloud/remote rendering, which allow the consumer to enjoy superior rendering quality without purchasing expensive hardware like these GPUs. The central idea of cloud rendering is simple. A consumer with a sufficiently fast Internet connection and a relatively low-end computing device may offload rendering processes to “the cloud” by purchasing a rendering service from a provider. Under these types of services, each time a consumer uses the service, one or more dedicated GPUs “in the cloud” are allocated to the user to process the rendering request for that user. When the user leaves the rendering session, the GPU resource is released and allocated to the next waiting user. This type of on-demand service increases hardware utilization and is advantageous to the service providers.

Specifically, the same GPU may be utilized on an as-needed basis by virtually unlimited potential users. Even high resource utilization of a GPU for most purposes and users only lasts a few hours at a time. Specifically, gaming sessions seldom last more than a few hours at a time. So, by dynamically allocating the GPUs only as they are actually used, the processing power may be in near constant use by deallocating for one user, then reallocating the GPU to another user. The individual need only pay for their actual use or for always-available use, not for the opportunity to use the GPU resources. The “rendered” content under these services, may then be delivered using systems designed for video streaming services (e.g Netflix®) in relatively high-bandwidth and low latency systems. As bandwidth and latency decrease, these types of services will only grow in popularity.

Currently, nVIDIA® and Sony® have successfully deployed cloud render service in the form of cloud gaming to the mass market. Their services are backed by private data centers distributed mainly in the U.S. continent and a few in European countries. These data centers include large numbers of custom computers incorporating GPUs or GPU capabilities. The system architecture for providing such cloud gaming is maintained confidentially, but the services rely heavily on proprietary hardware and software.

Before the arrival of cloud computing, there was no viable way for individuals or organizations to operate a private data center or provide remote rendering services with expensive GPUs. Now, with the significant advancement in cloud computing technologies, large information technology (IT) companies such as Amazon®, Google® and Microsoft® provide a wide range of cloud services and platforms for building highly scalable applications including cloud render service. These include various Google® services, Amazon® AWS® services, and Microsoft® Azure® services. In essence, these services provide on-demand compute capabilities or always-on server access. However, this hardware is widely standardized, and intended for general-purposes use, so it does not include powerful GPUs or other custom hardware or software specifically for rendering. Still, these services are available with low latency and on varying levels to virtually any individual in the United States and to many countries outside of the United States because these services have nearby servers in most major areas.

It would be beneficial if these services could be used along with a cloud render service framework that can be deployed on widely available cloud services, such as computing instances, queues, databases. With many on-line providers to choose from, organizations or even individuals who wish to build graphic intensive applications with cloud rendering support could use this service to expedite an efficient deployment of such services.

### DESCRIPTION OF THE DRAWINGS

FIG. 1 is a block diagram overview of a system for cloud render service.

FIG. 2 is a block diagram of a computing device.

FIG. 3 is a functional block diagram of user device interaction with a system for cloud render service.

FIG. 4 is a functional block diagram of a latency detection service.

FIG. 5 is a functional block diagram of a render fleet.

FIG. 6 is a flowchart of a process of rendering via a cloud service.

Throughout this description, elements appearing in figures are assigned three-digit reference designators, where the most significant digit is the figure number where the element is introduced, and the two least significant digits are specific to the element. An element that is not described in conjunction with a figure may be presumed to have the same characteristics and function as a previously-described element having the same reference designator.

### DETAILED DESCRIPTION

### Description of Apparatus

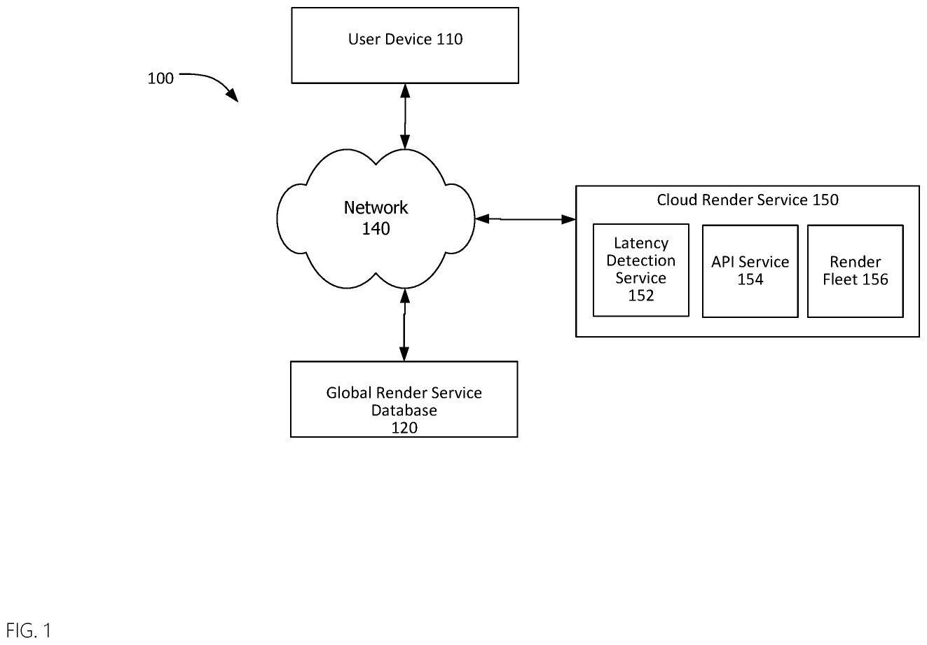

FIG. 1 is block diagram overview of a system 100 including a cloud render service 150, a global render service database 120, and a user device 110 (a computing device, discussed below, such as a mobile device, netbook, smart television laptop computer, or desktop computer) coupled via a network 140 (e.g., the Internet).

The user device 110 is a computing device that includes software operating to request rendering services and to receive and display two-dimensional frame-by-frame video of a three-dimensional rendered scene rendered by the cloud render service 150. The user device may incorporate software specifically designed to interact with the cloud render service 150 to accomplish these tasks.

The user device 110 is most likely a mobile device. However, the user device 110 may be a desktop computer, a laptop computer, a server computer, one of many different types of mobile devices (e.g. a smartphone or tablet computer), or a smartwatch. Virtually any user device 110 including a processor and memory may be capable of performing the functions described herein. Some types of user device 110 may be better suited to the functions described herein than others. A global render service database 120 operates on a computing device and is dedicated to store the contact information of all cloud render services offered from different regions or cloud providers. Herein, a database is a container that organizes, manages, and updates data. The data stored in database is organized as records, where each record is uniquely identified by a primary key. In addition to primary key, a record could have zero or many fields stored as key-value pairs. Unlike a queue, records in a database are not ordered and any record can be retrieved in constant time. A database also ensures data safety when operations are performed on the data by multiple services or users simultaneously.

A “service”, as used herein, is software operating on a computing device that performs one or more functions including the inner workings and components of that service. The service may interact with a client application through only a few exposed sub-components to perform one or more tasks. A high-level service (like cloud render services) usually has many collaborating small functions or services to fulfill its purpose or purposes. Cloud services herein are formed of both physical devices and logical cloud components or logical components. The physical devices are generally multipurpose computing devices incorporating various physical attributes such as hard drives, ram, processors, and network interconnections. The logical components may abstract the physical components such that they are no longer visible or work in concert with one another. For example, a series of tens or hundreds of physical computers may be integrated into a single logical component (e.g. one large “server”). But, since these are logical components, they are not necessarily intended to be tied to any particular implementation. It is the combination and interaction of various logical components that drive a service, like the cloud render service 150 to work in an efficient and automated fashion.

The cloud render service 150 can be divided into three components, as show in FIG. 1. The first component is the API service 154, which acts as the gateway to the cloud render service 150. An API (application programing interface) defines how a component should be used or interacted with by external components. For example, one aspect of the API may be a login service which enables users to login to the cloud render service 150, and limits access to the cloud render service 150 to only those authorized to utilize the service. An API key may be provided either in conjunction with a login or on its own to enable access to the API service 154. Thus the API server 154 provides the ability to carry out data messaging, client identity verification, and render fleet protection.

The second component is an optional latency detection service 152 which helps the user device 110 to determine a best service region, using a client-side application on the user device 110. A user device 110 could also bypass the latency detection process by obtaining its geographic location through other means such as a global positioning system (GPS) or cellular network and then connecting to the nearest service region. However, using the latency detection service 152 offers the most accurate process for region selection.

Latency is a measurement of time spent transporting a network packet from one host to another (e.g. from the user device 110 to the cloud render service 150). In many applications, latency is not a concern considering the latency of a packet that travels from U.S.A. to China is only about 300 milliseconds. An Internet user in the continental U.S. will have to wait at least 300 milliseconds before a browser may display any content travelling from a website located in China. However, for real-time interactive applications like cloud gaming, a latency of larger than 100 milliseconds will result in a noticeable delay between user generating input (e.g., a key press or mouse move or head turning in augmented reality applications) and seeing the resulting image rendered on the screen. This results in a poor user experience and significantly hinders the ability of the cloud rendering service 150 to effectively operate to render realistic three-dimensional worlds for a given user. Data are electrical signals traveling fiber optical cables or copper, so the single largest factor affecting latency is distance between the two endpoints. The most effective way to reduce latency is to reduce the distance between endpoints.

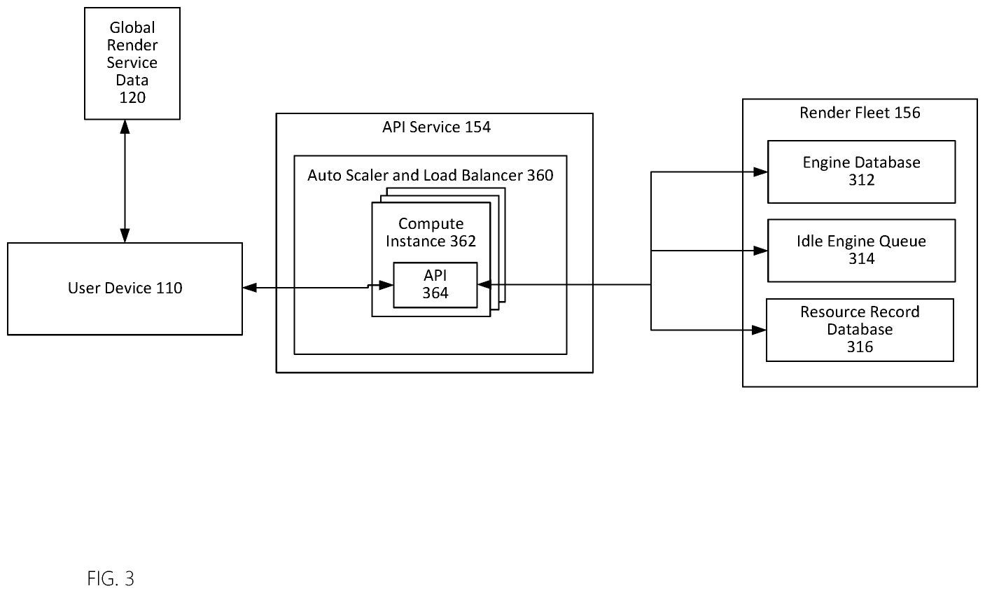

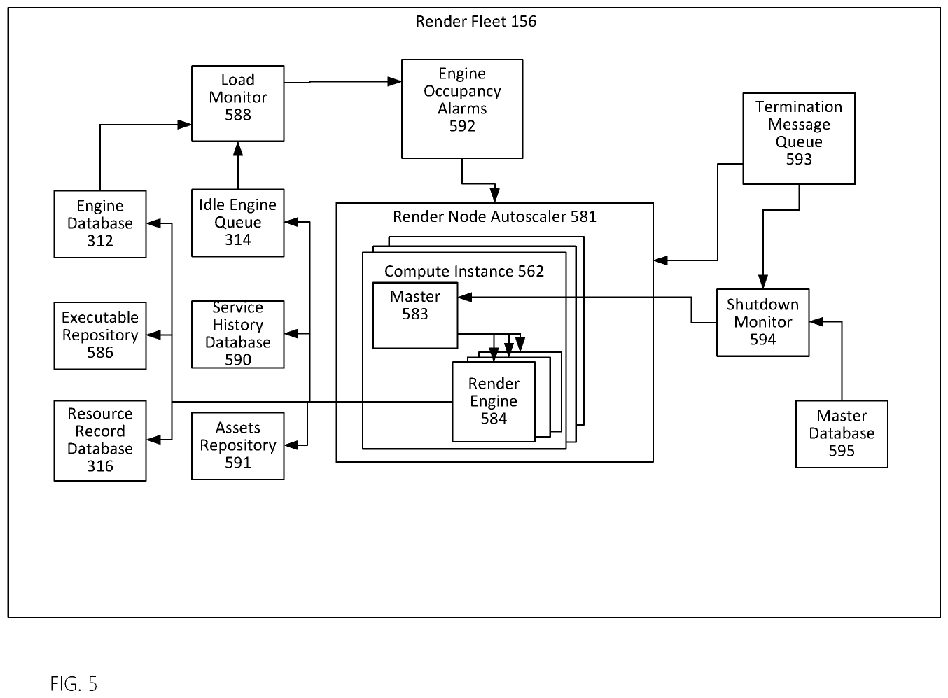

The last component, render fleet 156, which is discussed in more detail with respect to FIGS. 3 and 5, automatically manages, distributes, and scales compute instances. A compute instance or node is a virtual machine running on the cloud, with configurable hardware, configurable operation systems, and selectively pre-installed software. The words “virtual machine” refer to a logical computer, typically including at least a processor and short term memory, but which may also include dedicated hard drive space, and other capabilities. Virtual machines are typically used to wall off some portion of processing power from the rest of the physical device operating the virtual machine, typically so that a specific function may be carried out by that virtual machine. In this disclosure, each user seeking rendering may have a dedicated virtual machine performing that rendering.

The various states that a compute instance will go through in typical operation include, but are not limited to no state (e.g. not yet initiated), pending state, running state, stopping state, stopped state, shutting-down state, and terminated state. The state, in some situations, is useful because cloud providers usually allow developers to inject their custom program at the beginning or end of a state. For example, one might want to start a service program soon after the compute instance enters running state. Several components within the render fleet 156 are exposed to the API service 154 so that user devices 110 can make render requests to the render fleet 156 and maintain communications of data (e.g. motion data or controller data controlling the perspective to be rendered) to the render fleet 156.

As seen in FIG. 5, the render fleet 156 includes render engines 584 running on top of compute nodes 582. The render engines 584 are the software responsible for receiving input (e.g. motion data or location and orientation data associated with a three-dimensional or six degrees of freedom environment to be rendered), rendering that environment by creating the world from the perspective associated with the received data, and then converting that data into a two-dimensional data stream for streaming over a network to a viewing device. The compute instances 562 are virtual machines or sub-components of virtual machines that may be created and destroyed, primarily for the purpose of operating the render engines 584 on request by an external user for rendering capabilities.

The render node auto scaler 581 operates to dynamically allocate additional compute instances for the render fleet 156 as required. If resources are taxed, additional compute instances may be allocated to perform additional render operations. If the resources are not being adequately used, then some computer instances may be deallocated to more efficiently use resources. Before activating a render node auto scaler 581 to create render engines 584, several prerequisites must be met, including pre-allocating and initializing render fleet resources. The design and allocation of each resource is discussed below.

Master database 595 is a database that stores master runtime information including compute node ID, public and private IP address, master contact port number, and current state. Since there is only one master 583 per node, it is convenient to use the compute node ID as the primary key to uniquely identify the master 583. Within the system, any module sending commands/requests to the master 583 can look up its contacting IP address and port inside master database 595. In this way, the compute instance 562 knows for whom a given rendering operation is being performed. The shutdown monitor 594 is used to access contact information in the master database 595 to inform the master 583 to carry out a termination procedure upon request, for example, if a render service is ended for a given user. An API server may search through each entry in the database and count the total number of active masters for monitoring purposes, for example, to see the total load on a given compute instance 562 or the render fleet 156 as a whole.

Engine database 312 is the database for storing engine runtime information and each entry is uniquely identified by a universal unique ID (UUID) for a given user requesting the render operation(s). Fields of each record are engine contact IP address and ports, current state, master ID, and creation time. Throughout the lifetime of a given compute instance 562, a render engine's 584 state is constantly updated in the engine database 585.

Service history database 590 is an optional database for storing service records every time a user is served. Specifically, this record can calculate resources used, or compute time used, or other measures that may be used to determine how much capacity to make available and potentially to bill for the associated services. The collected data could be used to analyze statistics such as user demographics, average rendering time, and many other types of information.

Resource record database 316 is the database for storing information for all other queues and databases, which makes the naming of all other resource more flexible. When a render engine 584 is up and running, it will first make a request to resource record database 316 to discover all necessary resources allocated to this render fleet 156.

Idle engine queue 314 is a message queue for queuing contact information of idling render engine 584. A queue is a type of message container that strictly or loosely conforms to the first-in-first-out (FIFO) rule. The message consists of an optional message ID and message content. A cloud queue usually has atomicity characteristic for content safety when multiple simultaneous actions are performed on the queue, preventing a partial message or having partial message reside in the queue. The API server 154 has direct access to this queue and fetches a render engine 584 on behalf of the client application. The idle engine queue 314 also makes it easy to obtain total count of idling render engines 584 (since it is just the size of the queue) which is critical in making scale decisions.

Termination message queue 593 is a message queue for queuing termination signals from the render node auto scaler 581. These are requests to terminate individual compute instances upon termination of the rendering request from a user. The termination message queue 593 stores the ID of the node that the render node auto scaler 581 selected to terminate. This data may be used to update the service history database 590.

Assets repository 591 is a central location for storing all render assets such as texture, geometry and video files. This particular element may or may not be present, depending on the logical layout of the render fleet 156 and the computer instances. In some cases, the compute instance 581 may be configured to incorporate the assets as well. The render engine 584 can fetch assets either through a network mounted drive or through network downloading. The strategy selection depends on the size of the assets and the performance of the implementation.

Executable repository 586 is a central location for storing all render service-related executable programs, which includes an executable for render service, API service, latency detection, shutdown monitor, and occupancy monitor. Using a network mounted drive for executable repository 586 is sufficient and simplifies bootstrapping procedure. In some cases, the executable repository 586 may not be used and, instead, each compute instance may be generated on-demand with the desired associated program or programs.

So, for example, if a particular six degree of freedom experience is desired, and a rendering request is requested, the render node autoscaler may request creation of a compute instance 562 including the render engine 584. That may access the assets repository 591 and the executable repository 586 and create a specific compute instance 562 for that given six degree of freedom experience. That compute instance 562 may include all necessary assets and executables to perform the desired rendering functions. This type of system may be less-efficient by using disk space for the same content repeatedly, but it may be more secure or faster for certain types of operations. In other cases, central repositories like the assets repository 591 and the executable repository 586 that are simultaneously accessed by multiple compute instances may be best.

Load monitor 588 is a load monitor program on the render fleet 156. The program periodically queries engine database 312 and idle engine queue 589 to get the amount of active engines and the amount of idle engines, respectively. Load monitor 588 then calculates engine occupancy in percentage form and uploads to the engine occupancy metric in the cloud. This may be used by the auto scaler and load balancer 360 (FIG. 3) to determine whether additional compute instances, potentially in different physical locations, are allocated.

Engine occupancy alarms 592 are a set of alarms created based on various conditions of the engine occupancy metric, for example, occupancy greater than 90% and occupancy less than 70%. The engine occupancy alarms 592 are attached to the render node auto scaler 581 to trigger scaling operations for the render fleet when the alarms go off. In this way, the render fleet 156 may be maintained at a reasonable level of utilization, without overtaxing the individual compute instances.

When an auto scaler destroys a compute instance 562 due to low render engine 584 usage, there may be render engines 584 serving the clients, and terminating the compute node as a whole could disrupt all render services running on the compute instance 562. To prevent this from happening, termination must postpone until after all render services for a given compute instance 562 are completed.

When a compute instance 562 is first created or brought on-line, a render service is immediately executed to create multiple slave render engines 584 for that compute instance 562. The creation of multiple slave render engines 584 that share the same underlying computing resource, such as CPU, memory, storage, and any GPU. The render engine 584 may sit idle until they are allocated to a particular user for rendering operations. When the render node autoscaler 581 indicates that they should scale down, the render node autoscaler 581 may identify a particular compute instance for deallocation, so that no further render engine operations are allocated to what compute instance. Once the last user ceases using the compute instance, then it may be deallocated.

This is in contrast to the Sony PlayStation Now® and the nVIDIA GeForce Now® technology where each user obtains exclusive use of an entire compute node which is an inefficient use of compute resources, and requires the allocation of an entire virtual machine (or physical machine) to a given user. As can be ascertained, such systems are difficult to scale as utilization rises, and certainly difficult to scale in any location sufficiently close to a given user to maintain the low latencies required for adequate cloud rendering.

In the systems and methods described herein, the user devices for whom rendering is being performed are usually low-power (e.g., mobile devices, net books, laptop computers, desktop computers, tablets, or augmented reality or virtual reality headsets). These devices typically have lower-resolution screens and thus do not require the same level of detailed, high-resolution rendering as those played on higher-powered devices, such as desktop computers and TVs. The lower-powered user devices cannot fully utilize the computing power of an entire allocated compute node of a data center GPU, so sharing the same computing resources of a given compute instance more efficiently utilizes available resources and reduces costs by enabling a single virtual machine to simultaneously render three-dimensional content for multiple devices, if the characteristics (e.g. resolution desired) of those associated devices are such that it is possible.

High quality-of-service, meaning responsiveness of the render to changes in user position, VR or AR headset position, or controller movement, high image quality, meaning high resolution and high-quality rendering, and low latency are desirable for a positive user experience in all cases. High image quality increases bandwidth usage but can be accommodated with advanced compression technologies to reduce size and upgraded Internet service to increase bandwidth. This is because as the three-dimensional content is rendered by the render engine 584, it may virtually simultaneously be converted into a two-dimensional frame-by-frame video of the rendered content. The last five to ten years have resulted in many different algorithms for increasing the throughput of streamed, traditional two-dimensional video content. So, those problems are largely solved by the prior art, once the rendering is completed.

However, low latency in the vicinity of few milliseconds is difficult to achieve and largely governed by the distance between the user and the associated server tasked with performing the rendering. Low latency is not necessary for on-line media streamers like Netflix® because their content is not generated in real-time and is not interactive. For example, Netflix does not enable users to “look around” within a virtual world. A viewer's gaze is fixed as determined by a director. Therefore, each successive frame may be sent, or even pre-loaded, to ensure quality of service. In contrast, for interactive applications, the latency should be within 16 milliseconds to be considered acceptable so that movements of a controller, or a user's head may be accounted-for by the rendering service and the associated “next frame” of video may be sent reflecting that movement.

Unlike like the services provided by others which are highly reliant up on custom hardware and GPUs, systems described herein can deploy the service on most any publicly available cloud providers, operating upon traditional CPUs or, if available, lower-power GPUs. Because of the lack of any need for specialized hardware, the cloud services mentioned above, which have near ubiquitous presence in the U.S. and most of the world, are available for use. This significantly increases potential service coverage. Also, it enables very dynamic allocation of compute instances in any location where those services are available, effectively on demand.

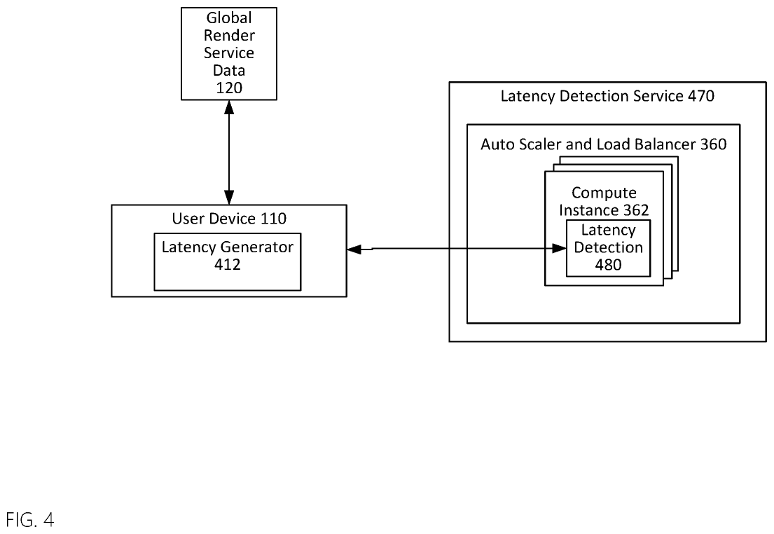

With so many service regions available, the user experience can be optimized by selecting the best region in terms of the lowest latency for the user. In achieving this goal, a latency detection service module 470, as shown in FIG. 4, can be added to every service region for reporting the latency between the user and each (or a subset of each) service region. As soon as a user is on-line, a latency generator 412 on the user device 210 may use a previously-obtained set of network addresses for the various available render fleets to query available service regions to obtain a list of latency measurements for each. Barring other limitations (e.g. a service region at its maximum utilization), the service region with the lowest latency is then selected as the serving region for the user device 100. Any subsequent render requests are submitted directly to the render fleet for the serving region and only a compute instance within the serving region will be utilized to serve that user.

As shown in FIG. 4, a latency detection service 470 includes an auto scaler and load balancer 360, wherein the auto scaler scales based on CPU usage and a load balancer balances incoming latency requests as well as utilization and availability among the serving nodes. The auto scaler and load balancer 360 sits before the group of compute instances 362 diverting incoming traffic to the compute instance with the least amount of utilization to evenly distribute incoming request to all compute instances within the render fleet. The latency detection service 470 runs on top of the compute instances and is responsible for handling latency detection 480 requests. To measure the latency between latency generator 412 and the service region, the current time of the user device is embedded in the request message and sent to the latency detection service 470. The request message is carried in user datagram protocol (UDP) protocol to maximum the latency measurement accuracy. Upon receiving the message from user device, the server measures the time difference between its current time and the time embedded in the request, and returns the latency measurement in the response message back to the latency generator 412. Due to the occasional network congestion, single latency measurements may not produce accurate result, thus multiple latency test is preferred.

When a user presses the play (or start or similar) button on their user device 110, the render request is received and processed in the back-end and the relevant information of an idle render engine 584 is returned to the user device 110 to enable the user device 110 to utilize the render engine 584 for rendering from that point forward.

Turning to FIG. 3, the API service 154 acts the agent between the user and compute instances 362. The API service 154 is convenient because it maintains all of the detailed operations going on unknown to the user, while still providing a seamless transition to rendered content. This indirect access to the compute instances 362 provides advantages.

First, an unauthorized user is immediately identified and rejected when connecting to any server because they do not have access. An authorized user carries a special token or API access key, following a login or other authentication, which allows the API server verify the user's identity and give an appropriate access level within the APIs. Second, the user is prevented from directly accessing any persistent data which helps to avoid possible data corruption. Third, new ways of accessing the cloud render service 150 can be easily added and existing methods can be easily improved through the modification of APIs 364 inside the API service 154 and the software operating on the associated user device 110.

Referring to FIGS. 1 and 3, the API service 154 is a single point of access to the cloud render service 150. It's primary function is to enable user devices, like user device 110, access a render engine 584. Since the API service 154 has access to all resources, data, history, and other information about the cloud render service 150; an administrator is allowed to view, manage, and modify various components of the cloud render service 150.

As can be seen from FIG. 3, the API service 154 uses similar architecture as the latency detection service 470 (FIG. 4) except the program running on top of the compute instance 362 is an API service program 364. API service 154 presents APIs 364 to the user device in the form of an HTTP or HTTPS request. For example, when a client desires to start a rendering procedure for a Human scene, an HTTP request like http://192.168.1.1/Render/HumanScene may be sent to the API server 154, and an HTTP response with a render engine description is received like (RenderEnginelP, RenderEnginePort). More APIs can be added later to provide additional functionalities, such as http://192.168.1.1/Manage/IdleEngineCount, which helps an administrator to determine a peek of the number of idle render engines in real-time. These and various other HTTP requests may be made.

Upon receiving render requests, the API service 154 will dequeue a previously-allocated, but idle render engine 584 from the idle engine queue 314 and forward the user render request to an idle engine 584. In general, there will not be a case in which no idle render engines are available, because as the threshold of available total rendering capability draws closer, an additional compute instance, with associated render engines will be allocated and initialized. An empty queue indicates render engines are unavailable at the moment, but the autoscaler operates to allocate more render engines which then soon become available.

An autoscaler is a component that creates and destroys compute instances according to a set of predefined scaling policies. For example, during a surge of incoming request, the average CPU usage of the compute instance group exceeds 90%. Generally, a compute instance group is dedicated for one task with all compute instances in the group having identical system configuration and running identical program. A scale up policy can instruct the auto scaler to create additional compute instances for the group to handle the surge. An administrator may alter the policies, which may be based upon available render engines, but also upon the types of rendering required (e.g. 4K rendering is more taxing on system resources than rendering at a low resolution for a mobile device). Scaling may take into account the types of rendering required or that may be required, based upon a historical analysis indicating that during certain times or days more or less resources are typically required.

The CPU usage may be a metric for the autoscaler in this example, but an administrator may define any custom metric. An alarm may be set to trigger when a metric satisfies certain predefined condition. In the previous example, “CPU usage exceeds 90%” can be an alarm and creating additional compute instance can be the subsequent event when the alarm goes off. Other conditions include memory usage, network utilization, and similar metrics.

In this scenario, the API service 154 may keep dequeuing render engines until an idle engine is successfully identified. The point of contact on the render engine 584 is the master 583. The agent first creates a new record in a service history database 590 that allows the administrators to monitor the daily usage of the render service and the operation status. The agent then sets engine state to “rendering” in the engine database 585 allowing the administrator to precisely identify the in-use render engines 584. Finally, the master 583 spawns a render engine 584 to serve the client and provides the connection information (e.g. network address and any authentication required) of the render engine back to the API service 154 which made the request.

The API service 154 then in turn provides the response to the user device 110. At this point, the user device 110 may access and rely upon the render engine for exclusive use (again the computing resource might be shared on the hardware level). Subsequently, communication is user device-to-engine and does not involve any work from the API or other components. Upon completing the rendering task, the render engine ceases rendering for that user device and render engine agents switch engine state from “rendering” state to “idle” state and pushes engine description back into idle engine queue 514 for future reuse or deallocation if overall utilization of the compute node goes down.

The render engine executable is retrieved from executable repository 586 and render assets are retrieved from assets repository 591. Since the assets and executable will be altered during daily operation, they can be optionally cached on the local drive for improved performance. The repositories may be stored in the form of an elastic file system which resembles a local folder but with actual storage on the cloud. Caching the repositories is simply copying the wanted assets into a local folder that uses local storage. The caching option may be passed to the render node as start-up parameter during the spawning to allocate the storage and access the data to be cached.

Providers like Amazon® AWS® allow the execution of a custom scripts at the creation of a compute instance and enable passing of the start-up parameters to the render instances. Using files from central shared repository is advantageous compared to using a local copy. The maintainer is able to make hot updates to the content of the repository without bringing the entire system down by simply replacing an existing render engine program with a new one in the executable repository 586. The reason is the master 583 for a given compute instance 562 is only concerned with the name of the executable, and not the actual content. By swapping the executables, the behavior of a service can be changed almost immediately and dynamically for any render engines 584 not currently operating. Custom services can be deployed using this render service framework by simply dropping in the desired version of the “render engine” and the backend then serves this purpose. In contrast, PlayStation Now® and GeForce Now® are rigid systems built on top of proprietary infrastructures. As a result, they are generally not suitable for reuse for other purposes or for widespread allocation for lower latency.

Testing has confirmed that four typical compute instances utilized according to the systems and methods described herein (with no GPU, costing about $0.1 per hour, per instance under current cloud service rates) are able to handle thousands of render requests per second from users. However, a GPU compute instance (with one GPU, costing about $1.0 per hour, per instance under current specialized cloud service rates) can only handle up to four rendering simultaneously for four users. Because the number of concurrent users using the rendering compute instance varies significantly throughout the day, cost-savings from this approach may be off-set due to the over-provision of render nodes to handle unknown numbers of users.

To minimize the operational cost and at the same time keep the user wait time as low as possible, the auto scaler and load balancer 581 can be added to the render fleet. The engine occupancy, calculated as the number of running render engines divided by total number of engine count, may be utilized as an alarm (e.g., indicator) to trigger the autoscaling operation and restore to occupancy to a target value (e.g. 85% utilization). When the occupancy drops below 70% or increases above 90%, the auto scaler and load balancer 581 will remove 15% or add 15%, respectively, of the current total number of engines. This may involve dynamically allocating compute instances as well. Having a buffer zone (70% to 90%) ensures the auto scaler and load balancer 581 will not be constantly performing scaling operations and balances reducing operation cost and minimizing user waiting time.

When scaling down, the render node autoscaler 581 may continuously collect utilization information for the overall render fleet 156 and push the information into the termination message queue 593. The termination message queue 593 may be monitored by shutdown monitor 594.

Upon a successful receipt of termination message, the shutdown monitor 594 parses the message, retrieves the master information from master database 595 using the node ID from the parsed message, and signals the master 583 of the node to terminate a given compute instance. When master 583 receives a termination signal, it forwards the signal to all render engines operating on that compute instance and waits for each render engine to quit. The render engines will not terminate until a given render engine is no longer in service, so that clients will not be interrupted in the middle of service while the render fleet 156 is scaling down. After making sure each render engine is not in service, the master 583 removes that engine record from the engine database 585. After all render engines have been successfully terminated, master 583 removes master record from master database 595 and sends a completion message back to the render node autoscaler 581 indicating that all render engines have been terminated. The render node autoscaler 581 then proceeds with the termination of the node and eventually removes the compute instantce 562 from the group.

Description of Processes

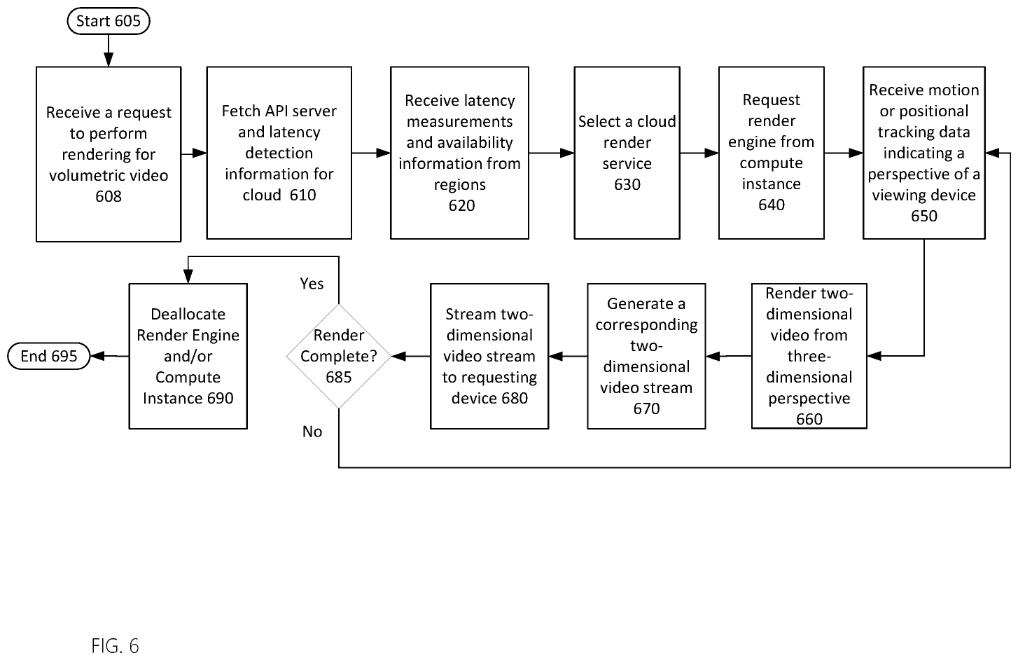

FIG. 6 is a flowchart of a process of rending via a cloud service. The process begins at 605 and ends at 695, but may take place for many requests and/or devices in rapid succession. One of the benefits of this system over prior art systems is that it can operate completely free of human interaction once initiated. At step 608, a request is made by the user on a user device for rendering of three-dimensional or volumetric video, e.g., via an application on the user device.

As used herein volumetric video is a three-dimensional environment represented through a series of frames based upon time in which a character, digital avatar, or user's perspective may move during that time. Volumetric video is video that is captured within the real-world using image cameras and represents real-world locations and objects. It is distinct from three-dimensional content such as video game engine content, AR content or VR content in that those three-dimensional types of content generally are not actual captures, captured by cameras, within the real world. They are instead fully or at least partially computer-generated environments.

At step 610, the application fetches API server and latency detection information for each cloud render service region. For example, an application operating on a user device may receive or fetch information from a global database, which may be available to the cloud render service 150 (FIG. 1). This database may contain the contact information of latency detection service and API service pairs for all service regions. As more cloud render fleets are deployed worldwide, their service contact information is automatically registered to the database.

At step 620, the application requests and receives latency measurements and availability information from each region. At step 630, the application selects a cloud render service region with availability that has the lowest latency. The latency detection is an optional step that enables the user device and the render service itself to determine the best cloud render fleet to utilize. As indicated above, latency is highly location dependent. In general, this process will enable the user device and cloud render fleet to select the compute instance that is likely to provide the best service to the user device.

At step 640, the application contacts API service 154 that is a part of the cloud render service 150 of the selected region to acquire a render engine. Optionally, the identity of the user device may be verified and any unauthorized access may be rejected during this process. The response message from the API service 154 may indicate whether a render engine is successfully identified. If not, the client application may choose to terminate the application or submit another request. Alternatively, this process may be handled automatically and invisibly to a user.

At step 650, if the render engine is successfully retrieved, the render engine will receive data from the user device, e.g., motion data, movement data, or positional tracking data indicating a viewing perspective from the user device. At this stage, the transmission of the motion data is important. The motion data indicates any movement or rotation of the viewing device, or for fixed devices like computer screens, any movement requested by controllers or keyboards within the three-dimensional environment or volumetric video. That data is transmitted by a user device to the particular rendering node so that the three-dimensional world may be rendered from the perspective indicated by that data.

At step 660, the render engine will render volumetric video, or other three-dimensional content, from the viewing perspective 660 indicated by the received motion or positional data. This rendering must happen very quickly so that it may be quickly transmitted back to the user device for viewing. Accordingly, the rendering, and the transmission must take place sufficiently quickly that a viewer on the user device is largely unaware of the rendering step and it appears fluid and natural in response to the requested movement, for example, head movement while wearing AR or VR goggles.

At step 670, the render engine will generate a corresponding two-dimensional video stream 670. At this step, the render engine converts the three-dimensional environment into a frame of two-dimensional video. This is done so that the video may be easily transmitted to a user device.

At step 680, the two-dimensional video stream will be streamed to the user device. As indicated above, various methods for efficiently encoding and transmitting two-dimensional video frames are known. Those are employed here to efficiently utilize bandwidth and to ensure smooth and rapid transmission of each rendered frame of video to the user device.

The process is a frame-by-frame process that continues so long as user input indicating movement or positional changes is received. Thus, a determination is made at 685 whether the rendering process is complete or whether additional input has been detected. If it is detected (“yes” at 685), then the process continues at 650 with receipt of that motion or positional tracking data.

If there is no motion data and the render is complete (“no” at 685), then the render fleet may deallocate the render engine and/or compute instance at 690. Here, the specific render engine that has been being used may be set to “idle” status because it remains allocated, but is now not being used. If the change to idle sets the total utilization sufficiently low, then the render engine may be deallocated completely so that the compute instance may be shut down to more efficiently manage available resources within the render fleet.

The process then ends at 695.

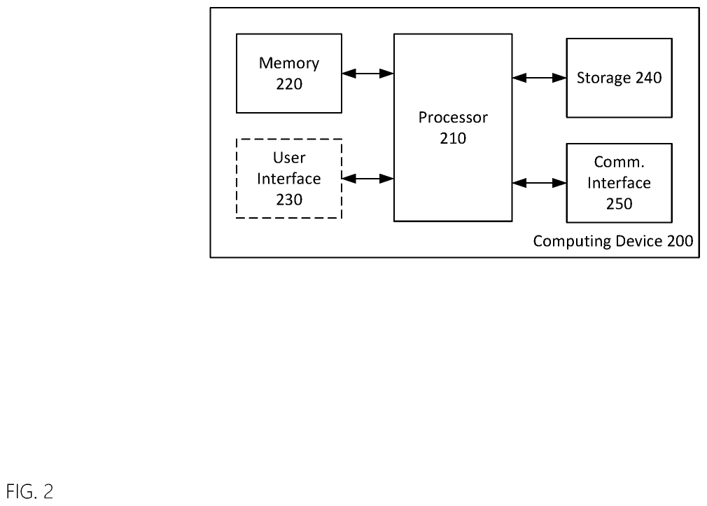

Turning now to FIG. 2, is a block diagram of an exemplary computing device 200, which may be the user device 110 of FIG. 1. As shown in FIG. 2, the computing device 200 includes a processor 210, memory 220, optionally, a user interface 230, along with storage 240, and a communications interface 250. Some of these elements may or may not be present, depending on the implementation. Further, although these elements are shown independently of one another, each may, in some cases, be integrated into another.

The processor 210 may be or include one or more microprocessors, microcontrollers, digital signal processors, application specific integrated circuits (ASICs), or a systems-on-a-chip (SOCs). The memory 220 may include a combination of volatile and/or non-volatile memory including read-only memory (ROM), static, dynamic, and/or magnetoresistive random access memory (SRAM, DRM, MRAM, respectively), and nonvolatile writable memory such as flash memory.

The memory 220 may store software programs and routines for execution by the processor. These stored software programs may include an operating system software. The operating system may include functions to support the communications interface 250, such as protocol stacks, coding/decoding, compression/decompression, and encryption/decryption. The stored software programs may include an application or “app” to cause the computing device to perform portions of the processes and functions described herein. The word “memory”, as used herein, explicitly excludes propagating waveforms and transitory signals.

The user interface 230, if present, may include a display and one or more input devices such as a touch screen, keypad, keyboard, stylus or other input devices.

Storage 240 may be or include non-volatile memory such as hard disk drives, flash memory devices designed for long-term storage, writable media, and proprietary storage media, such as media designed for long-term storage of photographic or video data. The word “storage”, as used herein, explicitly excludes propagating waveforms and transitory signals.

The communications interface 250 may include one or more wired interfaces (e.g. a universal serial bus (USB), high definition multimedia interface (HDMI)), one or more connectors for storage devices such as hard disk drives, flash drives, or proprietary storage solutions. The communications interface 250 may also include a cellular telephone network interface, a wireless local area network (LAN) interface, and/or a wireless personal area network (PAN) interface. A cellular telephone network interface may use one or more cellular data protocols. A wireless LAN interface may use the WiFi® wireless communication protocol or another wireless local area network protocol. A wireless PAN interface may use a limited-range wireless communication protocol such as Bluetooth®, Wi-Fi®, ZigBee®, or some other public or proprietary wireless personal area network protocol. The cellular telephone network interface and/or the wireless LAN interface may be used to communicate with devices external to the computing device 200.

The communications interface 250 may include radio-frequency circuits, analog circuits, digital circuits, one or more antennas, and other hardware, firmware, and software necessary for communicating with external devices. The communications interface 250 may include one or more specialized processors to perform functions such as coding/decoding, compression/decompression, and encryption/decryption as necessary for communicating with external devices using selected communications protocols. The communications interface 250 may rely on the processor 210 to perform some or all of these function in whole or in part.

As discussed above, the computing device 200 may be configured to perform geo-location, which is to say to determine its own location. Geo-location may be performed by a component of the computing device 200 itself or through interaction with an external device suitable for such a purpose. Geo-location may be performed, for example, using a Global Positioning System (GPS) receiver or by some other method.

### CLOSING COMMENTS

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. A system for cloud-based rendering of volumetric video, the system comprising a processor and associated memory, the memory storing instructions which when executed by a processor cause the processor to:
receive a request to perform rendering for a volumetric video from a device remote from the system;
select a cloud render service for performing rendering from among a plurality of geographically distributed cloud render services based, at least in part, upon a latency between the device and the plurality of geographically distributed cloud render services;
instruct the cloud render service to utilize a compute node for rendering the volumetric video; and
begin rendering of the volumetric video on the compute node, the rendering comprising:
receiving positional tracking data from the device indicating a perspective of a viewing device on the volumetric video;
rendering a selected volumetric video from the perspective; and
generating a two-dimensional video stream to correspond to the perspective of the selected volumetric video.

2. The system of claim 1 wherein the instructions further cause the processor to stream the two-dimensional video stream to the device.

3. The system of claim 1 wherein the instructions further cause the processor to determine the latency of the plurality of geographically distributed cloud render services.

4. The system of claim 3 wherein the latency of the plurality of geographically distributed cloud render services is determined by querying a latency detection service at each geographically distributed cloud render service.

5. The system of claim 1 wherein the instruction to select a cloud render service comprises an instruction to select a cloud render service with a present utilization below a predetermined threshold.

6. The system of claim 1 wherein the instruction to select a cloud render service further comprises an instruction to select a cloud render service based on a lowest latency.

7. The system of claim 1 wherein the latency is less than 16 milliseconds.

8. The system of claim 1 wherein the rendering utilizes only a portion of the compute node.

9. The system of claim 8 wherein another device remote from the system utilizes the compute node to render other volumetric video.

10. The system of claim 1 wherein the cloud render services are located on commercially available cloud providers.

11. A method for cloud-based rendering of volumetric video comprising
selecting a cloud render service for performing rendering from among a plurality of geographically distributed cloud render services based, at least in part, upon a latency between the device and the plurality of geographically distributed cloud render services;
instructing the cloud render service to utilize a compute node for rendering the volumetric video; and
rendering of the volumetric video on the compute node, the rendering comprising:
receiving positional tracking data from the device indicating a perspective of a viewing device on the volumetric video;
rendering a selected volumetric video from the perspective; and
generating a two-dimensional video stream to correspond to the perspective of the selected volumetric video.

12. The method of claim 11 further comprising streaming the two-dimensional video stream to the device.

13. The method of claim 1 further comprising determining the latency of the plurality of geographically distributed cloud render services.

14. The method of claim 13 wherein the latency of the plurality of geographically distributed cloud render services is determined by querying a latency detection service at each geographically distributed cloud render service.

15. The method of claim 11 wherein selecting a cloud render service further comprises selecting a cloud render service with a present utilization below a predetermined threshold.

16. The method of claim 11 wherein selecting a cloud render service further comprises an instruction to select a cloud render service based on a lowest latency.

17. The method of claim 11 wherein the latency is less than 16 milliseconds.

18. The method of claim 11 wherein the rendering utilizes only a portion of the compute node.

19. The method of claim 18 wherein another device remote from the system also utilizes the compute node to render other volumetric video.

20. The method of claim 11 wherein the cloud render services are located on commercially available cloud providers.
